(19) United States
(12) Patent Application Publication
(10) Pub. No.: US 2022/0314829 A1
(43) Pub. Date: Oct. 6, 2022

(54) Renewable and Environment Friendly Wind Powered Vehicle System

(71) Applicants: T. Bernard Kuzhangaira, Bradford (CA); Ashleigh Kuzhangaira, Bradford (CA)

(72) Inventors: T. Bernard Kuzhangaira, Bradford (CA); Ashleigh Kuzhangaira, Bradford (CA)

(21) Appl. No.: 17/711,443

(22) Filed: Apr. 1, 2022

Related U.S. Application Data
(60) Provisional application No. 63/169,518, filed on Apr. 1, 2021.

(51) Int. Cl. B60L 53/52; F03D 9/32; F03D 9/11; F03D 9/25; B60L 58/13; H02K 7/18; H02K 7/00; H02K 7/02

(52) U.S. Cl. CPC B60L 53/52; F03D 9/32; F03D 9/11; F03D 9/25; B60L 58/13; H02K 7/183; H02K 7/003; H02K 7/025; F05B 2220/706; F05B 2240/941; F05B 2260/421; B60L 2200/28

(57) ABSTRACT

The present invention relates to a wind powered, electrical power generating system for vehicles. The system uses inexhaustible and clean wind energy to produce electrical power for an electric vehicle. The system includes at least one wind turbine positioned to capture wind and coupled to an electromechanical generator for converting the wind into electrical power. The electrical power produced by the generator is stored in a battery pack, for providing electrical power to the DC motor of the vehicle. The battery pack includes three batteries, which either provide power to the DC motor, or are recharged by the generator, depending on their respective power levels. An auto change component swaps the first battery for the second battery, when the power level of the first battery falls below a predefined threshold value.

### CROSS-REFERENCE TO RELATED APPLICATION

The present application claims priority to, and the benefit of, U.S. Provisional Application No. 63/169,518, which was filed on Apr. 1, 2021 and is incorporated herein by reference in its entirety.

### FIELD OF THE INVENTION

The present invention relates generally to the field of eco-friendly power systems for vehicles. More specifically, the present invention relates to a novel wind powered vehicle power system used for providing power to vehicles, reducing frequent stops for recharging the vehicle's batteries. The system includes a wind turbine coupled to a generator. The generator is used for recharging three batteries and one of the three batteries can be used for providing power to the vehicle. Accordingly, the present disclosure makes specific reference thereto. Nonetheless, it is to be appreciated that aspects of the present invention are also equally applicable to other like applications, devices and methods of manufacture.

### BACKGROUND

By way of background, fossil fuels such as diesel and petrol are used for running conventional vehicles. The use of fossil fuels is not only costly but is also harmful for the environment. These fossil fuels are refined from crude oil and produce many harmful emissions when burned. Further, fossil-fueled vehicles are major sources of harmful pollutants, such as ground-level ozone and particulate matter. Pollutants, such as carbon monoxide, sulfur dioxide, nitrogen oxide, etc., are also released from the combustion of fossil fuels in conventional vehicles.

Vehicular pollution caused by conventional vehicles leads to poor air quality and climate change. Governments, automobile manufacturers and environmental organizations are making an effort to reduce vehicular pollution and thus have launched electric vehicles. The electric vehicles typically have a single electric battery for providing power to the vehicle. However, the energy provided by the battery is limited and keeping the battery charged for a long period of time is challenging. To recharge batteries, drivers need to stop at electric charging stations, which is time consuming, as a single battery results in low mileage coverage. Users desire a system that does not require frequent stops to recharge batteries, while also eliminating dependency on fossil fuels.

Existing means, such as fossil fuels and electricity provided by charging stations to power electric vehicles can be exhausted easily and drivers then have to spend valuable time and energy recharging batteries or refilling fuel, while the vehicle is not running. Users desire a power means that can effectively charge batteries and a charging system that has a plurality of batteries for providing a higher storage capacity.

Therefore, there exists a long felt need in the art for a power generation system for vehicles, that enables vehicles to stay on the road for a longer duration. There is also a long felt need in the art for a vehicle power generation system, that does not cause pollution and is environmentally friendly. Additionally, there is a long felt need in the art for a power system for vehicles, that provides a plurality of batteries to maintain constant battery power to the vehicle engine. Moreover, there is a long felt need in the art for a power generation mechanism, that reduces frequent stops to recharge the battery or refill fuel during a trip. Further, there is a long felt need in the art for a power generation mechanism that uses clean energy and is cost effective. Finally, there is a long felt need in the art for a clean power generation mechanism, that improves the overall charging experiences for an electric and conventional vehicle in a cost-effective manner.

The subject matter disclosed and claimed herein, in one embodiment thereof, comprises a wind powered system for providing power to an electric vehicle. The system is designed to produce electrical power from environmentally friendly and inexhaustible wind energy. The system further comprises at least one wind turbine mounted onto an electric vehicle, and an electromechanical generator configured to rotate or spin using the captured wind from the turbine to convert wind power into electrical power. The system further comprises a battery pack comprising three batteries, that are configured to be charged and recharged by the electrical power generated by the electromechanical generator and an auto changer module, which selects one of said batteries for providing power to the DC motor of the electric vehicle. Further, the auto changer automatically selects a second battery to replace a first battery, when the power level of the first battery is lower than a predefined threshold.

In this manner, the eco-friendly vehicle power generation system of the present invention, accomplishes all of the forgoing objectives and provides users with a system that uses a wind turbine system that turns a generator to produce electrical energy. The system eliminates dependency on carbon-based fuels, which in turn eliminates air pollution and maintains constant battery power, to prevent vehicle owners from losing power or spending unnecessary time charging batteries.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wind powered system for providing power to an electric vehicle. The system is designed to produce electrical power from environmentally friendly and inexhaustible wind energy. The system further comprises at least one wind turbine, an electromechanical generator configured to rotate or spin, using the captured wind from the wind turbine to convert the wind power into electrical power. The system further has a battery pack, comprising three batteries that are configured to be charged and recharged by the electrical power generated by the electromechanical generator and an auto changer module, which selects one of said batteries for providing power to the DC motor of the electric vehicle. Further, the auto changer automatically selects a second battery for replacing a first battery, when the power level of the first battery is lower than a predefined threshold.

In yet another embodiment, the wind turbine has an associated flywheel for storing mechanical energy produced by the wind turbine.

In yet another embodiment, the wind turbine is coupled to one or more wind inlets, positioned on an exterior surface of the vehicle, wherein wind flows from the wind inlets to the turbine through a channel having a plurality of vanes.

In yet another embodiment, a wind power system for vehicles is disclosed. The wind power system includes at least one wind inlet located at a front of the vehicle; a wind turbine installed at the bottom of the vehicle; a channel extending from the wind inlet to the wind turbine acting as a medium for the wind, the channel having a plurality of vanes for increasing wind flow of the wind before it reaches the wind turbine; a generator connected to the turbine through a substantially horizontal shaft, the generator is configured to turn along the shaft when the wind turbine rotates using the wind flow; and a battery pack including three batteries which is configured to charge and recharge the batteries using electric energy produced by the generator, wherein one of the three batteries is used for providing power to the vehicle and the two remaining batteries are charged or recharged based on a predetermined power level.

In yet another embodiment, the battery pack has a third battery included as a backup battery, wherein the excess load from the generator is dumped on the third battery when the other two batteries are fully charged by the generator.

In yet another embodiment, the system has a front mounted wind inlet and a side mounted wind inlet.

In yet another embodiment, the range of the vehicle is between 300 miles and 800 miles using the battery pack.

In yet another embodiment of the present invention, a method for providing clean electric energy to an electric vehicle, thereby reducing frequent stops for recharging the vehicle's battery and preventing pollution is disclosed. The method includes the steps of recharging a battery pack installed at a bottom of the vehicle using electrical power produced from wind energy, the wind energy is captured by one or more wind turbines installed on the vehicle; then, converting stored wind energy to electrical power by an electromechanical generator to charge and recharge the battery pack. The battery pack includes three batteries that are each configured to provide uniform electrical power to the vehicle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram view of one potential embodiment of the eco-friendly power generator system of the present invention designed for use with a vehicle in accordance with the disclosed architecture;

FIG. 2 illustrates a perspective view of one potential embodiment of the wind powered system of the present invention equipped on a vehicle in accordance with the disclosed architecture;

FIG. 3 illustrates a close-up view of the connection of the generator with the battery pack as embodied in the power generation system of the present invention in accordance with the disclosed architecture;

FIG. 4 illustrates a perspective view of the connection between a wind inlet positioned on the exterior surface of a vehicle and the wind turbine of the present invention in accordance with the disclosed architecture;

FIG. 5 illustrates a flow diagram showing the steps performed by one potential embodiment of the eco-friendly power generation system of the present invention in selection and auto changeover of batteries for providing electrical power to the DC motor in accordance with the disclosed architecture; and

FIG. 6 illustrates a bottom view of a vehicle equipped with one potential embodiment of the wind powered generation system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As stated supra, there is a long felt need in the art for a power generation system for vehicles, that enables the vehicles to stay on the road for a longer duration. There is also a long felt need in the art for a vehicle power generation system, that does not cause pollution and is environmentally friendly. Additionally, there is a long felt need in the art for a power system for vehicles, that provides a plurality of batteries to maintain constant battery power to an engine. Moreover, there is a long felt need in the art for a power generation mechanism that reduces frequent stops to recharge batteries or refill fuel during a trip. Further, there is a long felt need in the art for a power generation mechanism that uses clean energy and is cost effective. Finally, there is a long felt need in the art for a clean power generation mechanism that improves the overall charging experiences for electric and conventional vehicles in a cost-effective manner.

The present invention, in one exemplary embodiment, is a novel wind powered system for vehicles. The wind powered system includes one or more wind inlets located at the front, side and top of the vehicle; at least one wind turbine installed at the bottom of the vehicle; separate channels extending from the wind inlets to the wind turbine and acting as a medium for the wind; the channels having a plurality of vanes for increasing the wind flow of the wind before reaching the wind turbine; a generator connected to the turbine through a substantially horizontal shaft, the generator is configured to turn along the shaft when the wind turbine rotates using the wind flow; and a battery pack including three batteries, that is configured to charge and recharge the batteries using electric energy produced by the generator, wherein one of the batteries is used for providing power to the vehicle while the other two batteries are charging. Further, the battery providing power to the vehicle can also be auto changed with another of the two remaining batteries based on a predetermined power level.

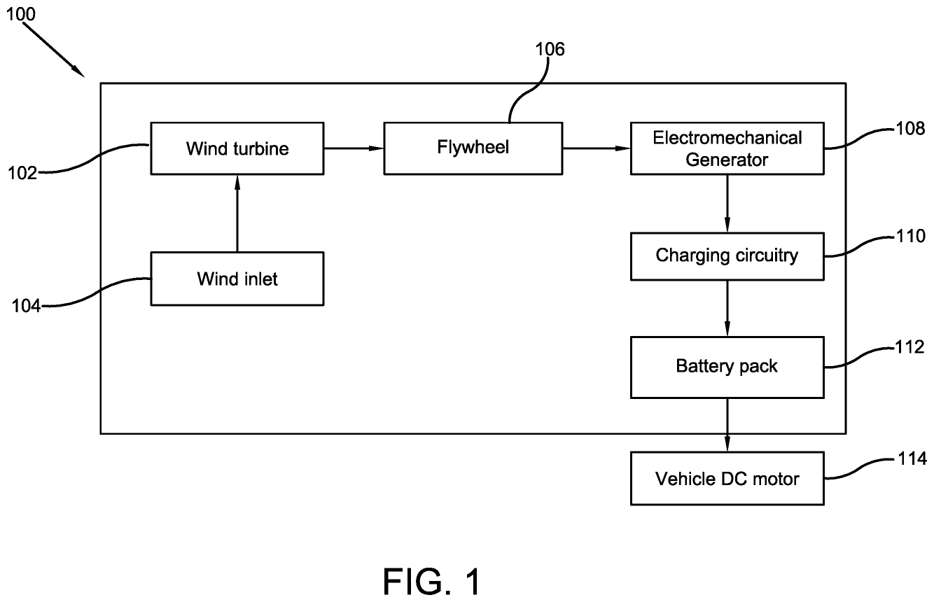

Referring initially to the drawings, FIG. 1 illustrates a block diagram view of the eco-friendly power generator system 100 of the present invention designed for a vehicle. The power generator system 100 of the present invention is designed for both electric and conventional vehicles. Further, the system 100 provides users with a renewable and environmentally conscious wind powered generation system that provides a plurality of electric batteries coupled to a generator which is rotated by a wind turbine, thus maintaining constant battery power and enabling the vehicle to stay on the road for a longer duration without requiring frequent battery charges.

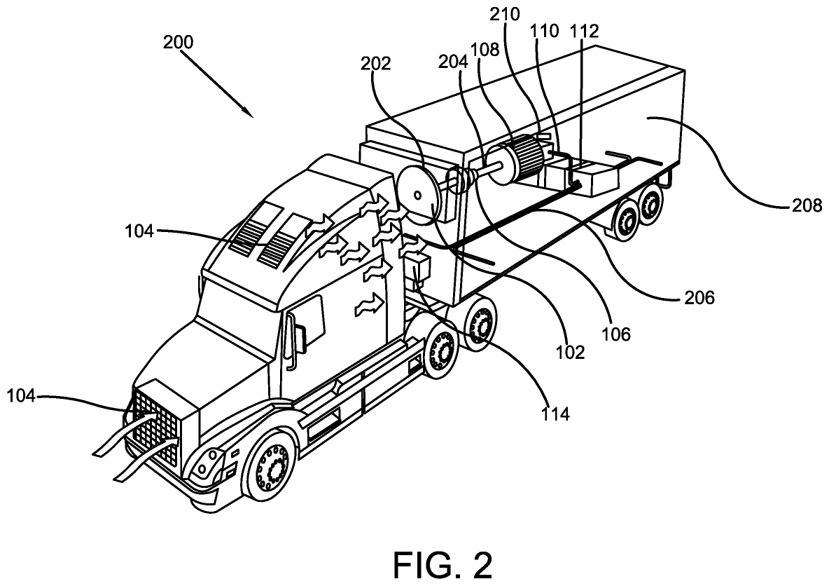

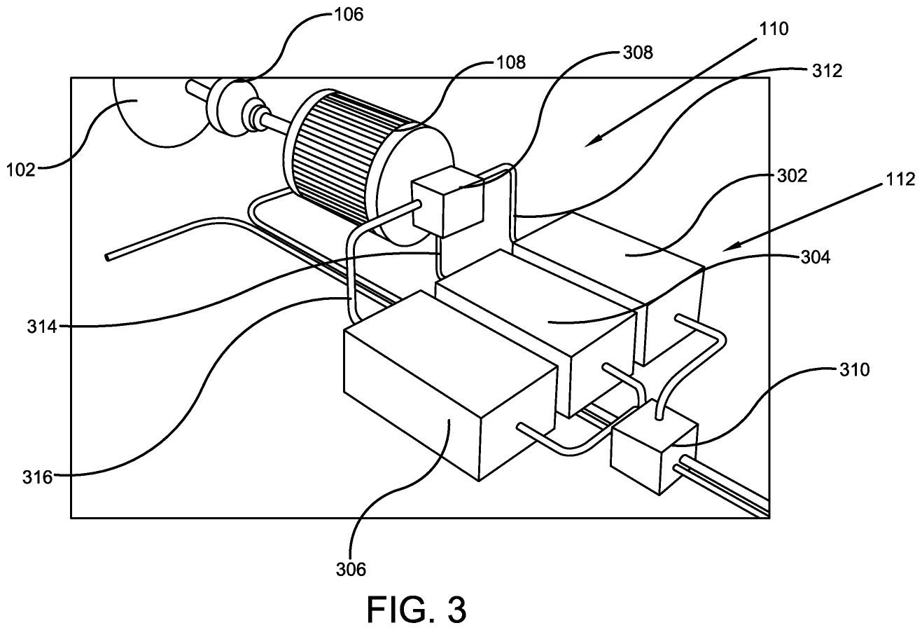

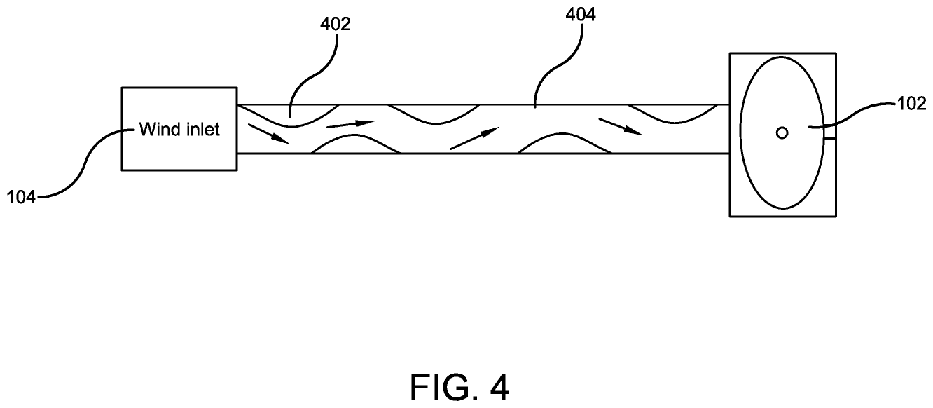

More specifically, the system 100 comprises at least one wind turbine 102 having a plurality of blades (as shown in FIG. 3) for rotating the turbine 102. The wind turbine 102 can be any suitable wind turbine as is known in the art based on the needs and/or wants of a user. The wind turbine 102 is configured to receive wind from one or more wind inlets 104 disposed on the vehicle. Any suitable number of wind inlets 104 can be utilized as is known in the art. The wind inlets 104 can be positioned on various surfaces of the vehicle and pass the wind through to the wind turbine 102, through a plurality of vanes, as best shown in FIG. 4. The wind turbine 102 is configured to rotate and the rotational motion of the wind turbine 102 is used for rotating an electromechanical generator 108 which generates electricity. The electromechanical generator 108 can be any suitable electromechanical generator as is known in the art based on the needs and/or wants of a user. The electromechanical generator 108 and the wind turbine 102 are connected through a shaft (shown in FIG. 2) that also comprises a flywheel 106. The flywheel 106 attached to the shaft is used for storing mechanical energy when the wind turbine 102 is in operation, due to the incoming wind from the wind inlets 104. The flywheel 106 can be any suitable flywheel 106 as is known in the art and is also configured to control the release of the stored mechanical energy to the electromechanical generator 108, when the mechanical energy (i.e., kinetic energy) produced by the rotation of the wind turbine 102 is more energy than can be handled by the electromechanical generator 108. This is advantageous in cases where a strong wind is blowing across the wind inlets 104 and the vehicle is also running at a high speed.

The electromechanical generator 108 is configured to produce electric energy using the mechanical energy of the wind turbine 102. The efficiency of the generator 108 is dependent on the mechanical energy produced by the rotation of the wind turbine 102. In the power system 100, the rotation of the wind turbine 102 depends on the flow rate of wind in cubic meter per second from the wind inlets 104. Further, a minimum rotation of the wind turbine 102 can be achieved by rotating the generator 108 to generate electricity even when the vehicle is in a stationary position due to the design and positioning of the wind turbine 102. The electricity generated by the generator 108 is used for recharging a plurality of batteries, more specifically three separate batteries referenced here collectively, as battery pack 112. The battery pack 112 is recharged using a charging circuitry 110. The charging circuitry 110 also has a changeover component (shown in FIG. 3 as 308) for charging and using a specific battery from the battery pack 112. The battery pack 112 is used for providing power to the DC motor 114 of the vehicle to allow the vehicle to run. Thus, the vehicle operates using the electric supply generated and provided by the wind powered vehicle system 100 of the present invention.

It should be noted that the wind turbine 102 can have any suitable number of blades as is known in the art, but in a preferred embodiment, the wind turbine 102 comprises between two to four blades, for creating minimal drag while the vehicle is in a moving state. Further, the wind turbine 102 can be mounted in any suitable position on the vehicle, such as on a vertical plane or a horizontal plane with a substantially horizontally or a substantially vertically disposed shaft within the vehicle. Also, the minimum wind speed required by the wind turbine 102 for rotating and generating electricity using the generator 108 is approximately 8 MPH, but can be any suitable speed as is known in the art, and the wind turbine 102 is designed to generate electricity even when the vehicle is stationary.

The wind inlets 104 positioned on the vehicle can also be positioned at any suitable position on the vehicle, as per the design of the vehicle. Further, any suitable electrical vehicle as is known in the art, such as cars, semi-trucks, etc., can be integrated with the wind powered vehicle system 100 during manufacturing of the vehicles, or the system 100 can be added to the vehicles aftermarket.

FIG. 2 illustrates a perspective view of one embodiment of the wind powered system 100 equipped on a vehicle 200 of the present invention. The vehicle 200 in the present embodiment is in the form of a semi-truck and comprises a plurality of wind inlets 104 positioned at the front and top of the vehicle 200. The wind inlets 104 are designed to provide maximum inlet efficiency without any decrease in wind speed or increase in drag, thereby providing maximum efficiency in rotation of the wind turbine 102. The wind inlets 104 are connected to the wind turbine 102 through vanes, as best shown in FIG. 4. Based on the design of the vehicle, the wind inlets 104 can be positioned on other suitable surface of the vehicle 200 as is known in the art, without compromising the aesthetics and aerodynamic drag of the vehicle 200.

In this embodiment, the wind turbine 102 is positioned below the trailer 208, such that the wind flow from the wind inlets 104 directly reaches the wind turbine 102 to rotate the blades 202 of the wind turbine 102. The wind turbine 102 is connected to the electromechanical generator 108 through a substantially horizontal shaft 204, thereby rotating the generator 108 to generate electricity. The flywheel 106 is disposed on the horizontal shaft 204 and positioned preferably between the wind turbine 102 and the generator 108. The flywheel 106 stores mechanical energy from the rotating wind turbine 102. Further, the generator 108 has an associated gearbox 210 for controlling the speed of the generator 108. The flywheel 106 is coupled to the gearbox 210 and the control from the flywheel 106 actuates the gearbox 210 to control the speed at which the generator 108 turns to generate electricity. The flywheel 106 may not be a separate component but can be integrated into the rotor (not shown) of the wind turbine 102 in some embodiments. Notwithstanding the depiction in FIG. 2, in a preferred embodiment of the present invention, the wind powered system 100 would be equipped on the tractor portion of the vehicle 200, as opposed to the trailer.

Further, the system 100 comprises a battery pack 112 that comprises approximately three batteries (as best shown in FIG. 3) which store electricity generated by the generator 108. However, any suitable number of batteries can be utilized as is known in the art depending on the needs and/or wants of a user. Typically, the electrical power is transferred to the battery pack 112 using the charging circuitry 110. The charging circuitry 110 can be any suitable, conventional electric wiring that is positioned in the vehicle and a separate wiring may extend from the generator 108 to each of the three batteries of the battery pack 112. Further, the battery pack 112 is connected to the DC motor 114 of the vehicle using external wiring 206. The external wiring 206 provides consistent and uniform electrical power for the vehicle to run. Thus, the system 100 provides longer mileage to the vehicle 200 and requires less frequent stops for battery and fuel recharging/refilling.

It should be appreciated, that since electricity by the system 100 is generated using wind power, which is an unlimited natural resource, the system 100 can easily replace fossil fuel power generation and eliminate the need for an internal combustion engine. Therefore, fuel expenses can be reduced as unnecessary fuels are not used. In addition, air pollution is reduced as there are no exhaust gases emitted.

FIG. 3 illustrates a close-up view of the connection of the generator with the battery pack as embodied in the power generation system 100 of the present invention. As stated supra, the battery pack 112 of the system 100 of the present invention includes three batteries referred to herein as a first battery 302, a second battery 304 and a third battery 306. A changeover circuit 308 is connected to the generator 108 and to the charging circuitry 110 for automatic changeover of the active connection of the generator 108 with one of the batteries 302, 304, 306. In use, when the vehicle in which the system 100 is installed is operating, the second battery 304 is charged or recharged by the generator 108, while the first battery 302 is used for providing power to the DC motor of the vehicle through the DC connector 310. The third battery 306 is included as a backup battery, which can be utilized by the system 100 when both the first battery 302 and the second battery 304 are being charged or recharged by the generator 108. A changeover from the first battery 302 to the second battery 304 can also be done to provide consistent electrical power to the vehicle for operation, without the need to stop and recharge the first battery 302 after it has been depleted.

Further, the wind turbine 102 of the system 100 operates in conjunction with the flywheel 106, which stores electrical energy created by the generator 108. The charging circuitry 110 connects to the generator 108 and then to the batteries 302, 304, 306. As shown, the charging circuit 110 has separate wires from the generator 108 to the batteries 302, 304, 306. More specifically, the first battery 302 is connected through the first wire 312, the second battery 304 is connected through the second wire 314, and the third battery 306 is connected through the third wire 316 for individual and separate connections. The batteries 302, 304, 306 can be of the same capacity or alternatively, the first battery 302 can have the maximum storage capacity followed by the second battery 304 having less storage capacity and then the third battery 306 having the least storage capacity.

The battery pack 112 allows the DC motor of the vehicle to receive consistent and uniform electrical power from one of the three batteries 302, 304, 306, thereby increasing the mileage and decreasing the stops required for recharging batteries, and thus saving effort and cost. Any suitable number of batteries can be utilized within the battery pack 112 as is known in the art depending on the wants and/or needs of a user. However, in a preferred embodiment, the battery pack 112 comprises three batteries 302, 304, 306. Each battery 302, 304, 306 can have the power capacity in the range of approximately 15 kWh-30 kWh, or any other suitable power capacity as is known in the art.

FIG. 4 illustrates a perspective view showing the connection between a wind inlet 104 positioned on an exterior surface of a vehicle and the wind turbine 102. As shown, the wind inlet 104 is configured to pass wind flow to the wind turbine 102 through a plurality of vanes 402 disposed within a channel 404. The channel 404 connects the wind inlet 104 and the wind turbine 102 together. The vanes 402 are configured to increase the speed of the wind flow before the wind reaches the wind turbine 102, such that the wind turbine 102 is rotated at an adequate speed. Any suitable number of vanes 402 can be utilized within the channel 404 as is known in the art, and any suitable number of channels 404 can be utilized as is known in the art depending on the needs and/or wants of a user.

In vehicles having more than one wind inlet 104, separate channels 404 and vanes 402 may be positioned inside, outside or under the vehicle to carry the wind flow to the wind turbine 102, or in any other suitable position as is known in the art. In one embodiment, there may be a plurality of wind turbines 102, wherein each wind turbine 102 is associated with one or more wind inlets 104. The multiple wind turbines 102 may be connected to the battery pack, for recharging the batteries to provide electrical power to the DC motor of the vehicle.

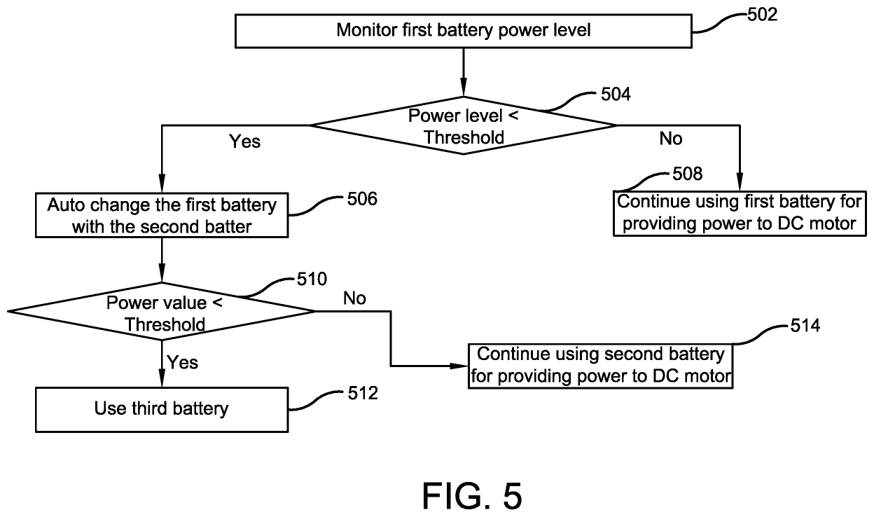

FIG. 5 illustrates a flow diagram showing the steps performed by the eco-friendly power generation system 100 of the present invention in the selection and auto changeover of batteries for providing electrical power to the DC motor. One main feature of the system 100 of the present invention is that the system 100 continuously monitors the power level of the battery pack, including the power level of the batteries within the battery pack. Specifically, at 502 the first battery's power level is monitored. Then at 504, the power level of the first battery is compared to a predetermined power threshold value. The predetermined threshold value can be in the range 20%-25% of the total power value of the first battery. If it is determined that the first battery level is less than the predetermined threshold value, then at 506, the process auto changes the first battery with the second battery, which enables the second battery to provide power to the vehicle, ensuring that the vehicle continuously runs without losing power. If it is determined that the first battery level is more than the predetermined threshold value, then at 508, the first battery is continued to be used for providing power to the DC motor of the vehicle.

If the second battery is enabled, the process continues, then at 510, when the electrical power from the second battery is used, it is determined if the second battery power is less than the predetermined threshold value. If it is determined that the second battery power value is less than the predetermined threshold value, then at 512, the third battery or back up battery is used for providing power to the vehicle. If the second battery power value is more than the predetermined threshold value, then at 514, the second battery is continued to be used for providing power to the DC motor of the vehicle.

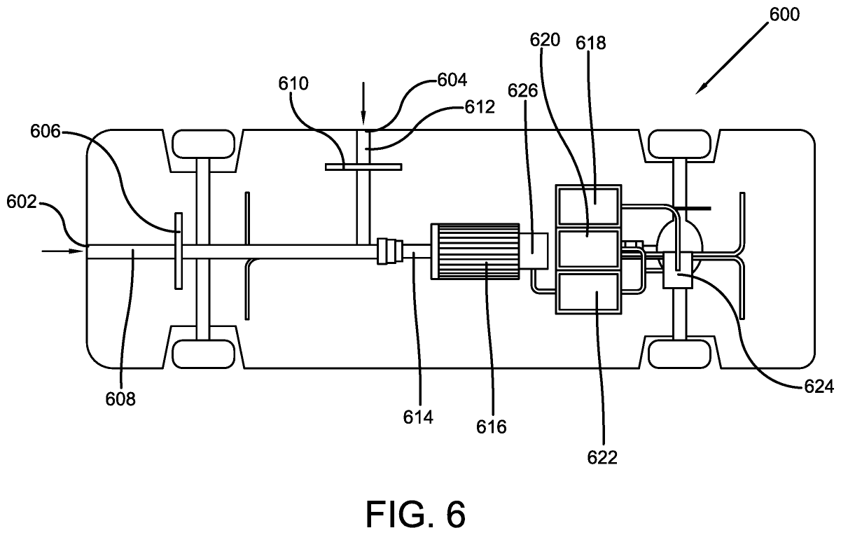

FIG. 6 illustrates a bottom view of a vehicle equipped with the wind powered generation system 100 of the present invention. As shown, the vehicle 600 has two wind inlets; a front wind inlet 602 and a side wind inlet 604. A first wind turbine 606 is connected to the front wind inlet 602 through a first channel 608 and a second wind turbine 610 is connected to the side wind inlet 604 through a second channel 612. Both the channels 608, 612 have vanes to create a high flow of wind which is then transferred to the wind turbines as described in FIG. 4.

The wind turbines 606, 608 are connected to the shaft 614, such that the generator 616 is turned in a synchronous manner by both the wind turbines 606, 608 for effectively generating electricity. Further, the batteries 618, 620, 622 are used for storing the electrical energy generated by the generator 616. Any one of the batteries 618, 620, 622 is then used for providing power to the DC motor 624 of the vehicle 600. The autochanger 626 is then used for automatically changing over the batteries based on the available power in the batteries and is also used for providing uniform and continuous power to the vehicle 600.

It should be noted that although the vehicles shown in various embodiments are an exemplary semi-truck model or a car model, the wind power system 100 described herein may be used in connection with any other suitable type of vehicle on land, air and sea as is known in the art. For example, the system 100 described herein can be used in connection with any suitable automobile, tractor, boat, etc. Such vehicles may be wholly or partially electrically powered.

Further, the system 100 can be built as separate modules and connected or manufactured as one integrated module. Also, the system 100 can be mounted horizontally or vertically on any vehicle/unit that uses kinetic energy. Further, the sizes of the components may vary depending on the physical size of the existing electric vehicle, the capacity of the required batteries and/or the charging time required for each battery.

In some implementations, the wind turbines (including their blades) may be made out of a carbon fiber type material that may or may not need to be reinforced with Kevlar to aid in the strengthening and efficiency of capturing the wind.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wind powered vehicle power system”, “eco-friendly power generation system”, “power system”, “renewable power generation system”, and “system” are interchangeable and refer to the wind powered vehicle power system 100 of the present invention.

Notwithstanding the forgoing, the wind powered vehicle power system 100 of the present invention can be of any suitable size and configuration as is known in the art without affecting the overall concept of the invention, provided that it accomplishes the above-stated objectives. One of ordinary skill in the art will appreciate that the size, configuration and material of the wind powered vehicle power system 100 as shown in FIGS. 1-6 is for illustrative purposes only, and that many other sizes and shapes of the wind powered vehicle power system 100 are well within the scope of the present disclosure. Although the dimensions of the wind powered vehicle power system 100 are important design parameters for user convenience, the wind powered vehicle power system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wind powered vehicle power generator system designed to maintain a constant battery power for a vehicle, the wind powered vehicle power generator system comprising:
at least one wind turbine having a plurality of blades for rotating the at least one wind turbine;
at least one wind inlet disposed on the vehicle for passing a wind through to the at least one wind turbine;
an electromechanical generator; and
a plurality of batteries powered by the electromechanical generator, wherein the wind acts to rotate the at least one wind turbine which, in turn, rotates the electromechanical generator to generate the electrical energy to power the plurality of batteries to operate the vehicle.

2. The wind powered vehicle power generator system of claim 1 further comprising a shaft that connects electromechanical generator with the at least one wind turbine.

3. The wind powered vehicle power generator system of claim 2 wherein the shaft comprises a flywheel.

4. The wind powered vehicle power generator system of claim 3, wherein the flywheel stores a mechanical energy from the at least one wind turbine.

5. The wind powered vehicle power generator system of claim 4, wherein the flywheel is configured to control a release of the stored mechanical energy to the electromechanical generator.

6. The wind powered vehicle power generator system of claim 1, wherein the plurality of batteries comprises three batteries.

7. The wind powered vehicle power generator system of claim 6 further comprising an auto change component for charging and using a specific battery from the plurality of batteries.

8. The wind powered vehicle power generator system of claim 7, wherein the plurality of batteries provide power to a DC motor of the vehicle.

9. A wind powered vehicle power generator system designed to maintain a constant battery power for a vehicle, the wind powered vehicle power generator system comprising:
at least one wind turbine having a plurality of blades for rotating the at least one wind turbine;
at least one wind inlet disposed on the vehicle for passing a wind through to the at least one wind turbine;
a flywheel that stores a mechanical energy from the at least one wind turbine;
an electromechanical generator that is rotatable to generate an electricity; and
a battery pack powered by the electromechanical generator, wherein the wind acts to rotate the at least one wind turbine which, in turn, rotates the electromechanical generator to generate the electricity using the mechanical energy from the at least wind turbine to power the battery pack to operate the vehicle.

10. The wind powered vehicle power generator system of claim 9 further comprising a shaft that is connected to, and positioned between, each of the electromechanical generator and the at least one wind turbine.

11. The wind powered vehicle power generator system of claim 10, wherein the flywheel is configured to control a release of the stored mechanical energy to the electromechanical generator.

12. The wind powered vehicle power generator system of claim 11, wherein the electromechanical generator comprises an associated gearbox for controlling a speed of the electromechanical generator.

13. The wind powered vehicle power generator system of claim 12, wherein the flywheel is coupled to the associated gearbox.

14. The wind powered vehicle power generator system of claim 9, where the battery pack comprises three batteries.

15. The wind powered vehicle power generator system of claim 9 further comprising a channel connecting the at least one wind inlet and the at least one wind turbine.

16. The wind powered vehicle power generator system of claim 15, wherein the channel comprises a plurality of vanes disposed within.

17. A method of selecting and auto changing of a plurality of batteries in a wind powered vehicle power generator system to power a vehicle, the method comprising the steps of:
continuously monitoring a power level of a first battery, a second battery and a third battery within a battery pack;
comparing the power level of the first battery to a predetermined power threshold value;
if first battery power level is less than the predetermined power threshold value, then changing the first battery with the second battery to ensure that the vehicle does not lose power; and
if first battery power level is more than the predetermined power threshold value, then continuing to use the first battery to power the vehicle.

18. The method of claim 17, wherein the predetermined power threshold value is in a range of 20-25% of a total power value of the first battery.

19. The method of claim 17 further comprising the step of determining if the second battery power is less than the predetermined threshold value if the second battery is enabled.

20. The method of claim 19 wherein if it is determined that the second battery power value is less than the predetermined threshold value, then changing the second battery with the third battery.
